(19) United States
(12) Patent Application Publication
(10) Pub. No.: US 2020/0021059 A1
(43) Pub. Date: Jan. 16, 2020

(54) Connector Having Locking Structure

(71) Applicant: LG Chem, Ltd., Seoul (KR)

(72) Inventors: Sung Gyu Kim, Daejeon (KR); Sang Eun Jung, Daejeon (KR)

(73) Assignee: LG Chem, Ltd., Seoul (KR)

(21) Appl. No.: 16/491,043

(22) PCT Filed: Sep. 17, 2018
(86) PCT No.: PCT/KR2018/010893

§ 371 Date: Sep. 4, 2019

(30) Foreign Application Priority Data
Sep. 18, 2017 (KR) 10-2017-0119483

(51) Int. Cl. H01R 13/627

(52) U.S. Cl. CPC H01R 13/6273; H01R 12/716

(57) ABSTRACT

A connector having locking structure which are formed at left and right sides of a male connector and left and right sides of a female connector and used to doubly couple the male connector and the female connector, thereby preventing the male connector and the female connector in a coupled state from being warped to the left and right.

### CROSS-REFERENCE TO RELATED APPLICATIONS

The present application is a national phase entry under 35 U.S.C. § 371 of International Application No. PCT/KR2018/010893 filed Sep. 17, 2018, published in Korean, which claims priority from Korean Patent Application No. 10-2017-0119483 filed on Sep. 18, 2017, all of which are incorporated herein by reference.

### TECHNICAL FIELD

The present invention relates to a connector having locking structure, and more particularly, to a connector having locking structure which are formed at left and right sides of a male connector and left and right sides of a female connector and used to doubly couple the male connector and the female connector, thereby preventing the male connector and the female connector in a coupled state from being warped to the left and right.

### BACKGROUND ART

In general, a printed circuit board refers to a product implemented as an electrical conductor by forming a copper (Cu) thin layer on an insulating member in the form of a wiring diagram to form electrical wiring for connecting components based on circuit design, and various configurations and shapes of the printed circuit boards are used for various electronic products (e.g., home appliances, computers, etc.).

Meanwhile, in addition to a printed circuit, multiple electric connectors are used on a surface of the printed circuit board in order to transmit electrical signals from the outside, and the electric connector generally includes a pair of female and male connectors.

More specifically, the electric connector is structured such that the female connector is fixed to the printed circuit board, and the male connector is coupled to one side of the female connector to transmit the electrical signal to the female connector, thereby transmitting the electrical signal to the printed circuit board.

Therefore, it is important to accurately couple the male connector and the female connector while preventing the male connector and the female connector from being warped, in order to easily transmit the electrical signal from the male connector to the female connector, and it is important to prevent structures of the male connector and the female connector in the coupled state from being warped by external pressure.

However, because the connector in the related art is structured such that an upper end of the female connector is just fitted with a lower end of the male connector, there is a problem in that the male connector and the female connector in the coupled state are warped to the left and right by external pressure, and there is a problem in that the male connector or the female connector is broken down when the male connector and the female connector in the coupled state are warped to the left and right because of the problem, which may lead to a breakdown of the printed circuit board.

Meanwhile, recently, like Korean Utility Model Registration No. 20-0454088 (Electric Connector), a technology capable of preventing the male connector and the female connector from being coupled reversely has been developed and commercialized, but a technology capable of preventing the male connector and the female connector in the coupled state from being warped has not yet been developed, and as a result, the aforementioned problem that the male connector and the female connector in the coupled state may be warped to the left and right by external pressure still cannot be solved.

### DETAILED DESCRIPTION OF THE INVENTION

### Technical Problem

An object of the present invention is to provide a connector having locking structure which are formed at left and right sides of a male connector and left and right sides of a female connector and used to doubly couple the male connector and the female connector, thereby preventing the male connector and the female connector in a coupled state from being warped to the left and right.

### Technical Solution

A connector having locking structure according to an exemplary embodiment of the present invention may include: a male connector which has, at one side thereof, fixing members that protrude with a predetermined size; and a female connector which is coupled to the male connector and has, at one side thereof, connecting members that are fitted with and coupled to the fixing member.

In the exemplary embodiment of the present invention, the fixing members may be formed at both sides of the male connector, respectively.

In the exemplary embodiment of the present invention, an anti-withdrawal protrusion, which prevents the fitted and coupled connecting member from being withdrawn, may be formed at one side of the fixing member.

In the exemplary embodiment of the present invention, an inclined surface, which allows the connecting member to be fitted in a sliding manner, may be formed at the other side of the fixing member.

In the exemplary embodiment of the present invention, the connecting member may be made of a flexible material.

In the exemplary embodiment of the present invention, the connecting member may be fitted with and coupled to the fixing member after the connecting member is fitted with the fixing member in a state in which the connecting member is bent.

In the exemplary embodiment of the present invention, the connecting member may have a thickness of 0.5 mm to 0.7 mm

### Advantageous Effects

One aspect of the present invention provides the connector having the locking structure which are formed at the left and right sides of the male connector and the left and right sides of the female connector and used to doubly couple the male connector and the female connector, thereby preventing the male connector and the female connector in the coupled state from being warped to the left and right.

### BRIEF DESCRIPTION OF DRAWINGS

FIG. 1 is a perspective view schematically illustrating a configuration of a connector having locking structure according to an exemplary embodiment of the present invention.

FIG. 2 is a front view schematically illustrating the configuration of the connector having the locking structure according to the exemplary embodiment of the present invention.

FIG. 3 is a front view schematically illustrating a configuration of a connector having locking structure according to another exemplary embodiment of the present invention.

### DETAILED DESCRIPTION

Hereinafter, the present invention will be described in detail with reference to the accompanying drawings. Here, repeated descriptions, and detailed descriptions of publicly known functions and configurations will be omitted so as to avoid unnecessarily obscuring the subject matter of the present invention. The exemplary embodiments of the present invention are provided to more completely explain the present invention to a person with ordinary skill in the art. Therefore, shapes and sizes of elements illustrated in the drawings may be exaggerated for a clearer description.

Unless explicitly described to the contrary, the word “comprise” or “include” and variations, such as “comprises”, “comprising”, “includes” or “including”, will be understood to imply the inclusion of stated constituent elements, not the exclusion of any other constituent elements.

In addition, the term “unit”, “part”, or the like, which is described in the specification, means a unit that performs one or more functions or operations, and the “unit”, “part”, or the like may be implemented by hardware, software, or combination of hardware and software.

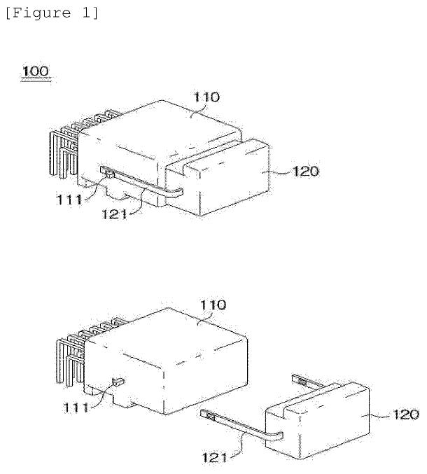

FIGS. 1 to 3 are views schematically illustrating a configuration of a connector 100 having locking structure according to an exemplary embodiment of the present invention.

Referring to FIGS. 1 to 3, the connector 100 having the locking structure according to the exemplary embodiment of the present invention may include a male connector 110 and a female connector 120 as constituent elements thereof.

In this case, as illustrated in FIGS. 1 to 3, the connector 100 may be structured such that an upper end of the female connector 120 is coupled to a lower end of the male connector 110, but it is noted that the present invention is not limited thereto.

In addition, it is noted that the connector 100 having the locking structure according to the exemplary embodiment of the present invention may be applied to any field including a printed circuit board to which the connector may be applied.

First, the male connector 110 of the connector 100 having the locking structure according to the exemplary embodiment of the present invention will be described with reference to FIGS. 1 to 3, and the male connector 110 according to the exemplary embodiment of the present invention may include, at one side thereof, fixing members 111 which protrude with a predetermined size.

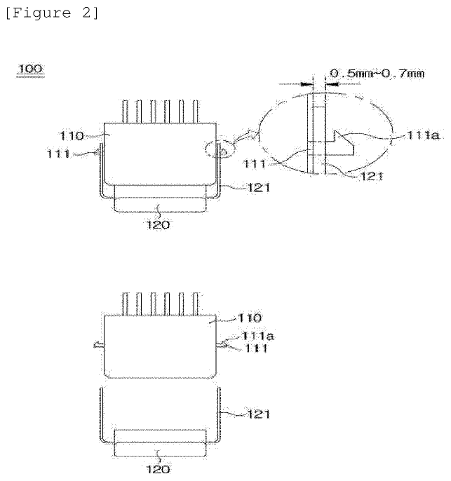

In this case, the fixing members 111 may be formed at left and right sides of the male connector 110 (left and right sides of the male connector 110 based on FIG. 2), respectively. However, the positions at which the fixing members 111 are formed as illustrated in FIGS. 1 to 3 are determined according to the exemplary embodiment of the present invention, but it is noted that the positions at which the fixing members 111 are formed are not limited to the positions illustrated in FIGS. 1 to 3.

Next, the female connector 120 according to the exemplary embodiment of the present invention may include, at one side thereof, connecting members 121 which are coupled to the male connector 110 and fitted with and coupled to the fixing members 111.

In this case, the connecting members 121 may be formed at left and right sides of the female connector 120 (left and right sides of the female connector 120 based on FIG. 2), respectively, so as to be fitted with and coupled to the fixing members 111 which are formed at the left and right sides of the male connector 110, respectively. However, the positions at which the connecting members 121 are formed as illustrated in FIGS. 1 to 3 are determined according to the exemplary embodiment of the present invention, but it is noted that the positions at which the connecting members 121 are formed are not limited to the positions illustrated in FIGS. 1 to 3.

In addition, a hole into which the protruding fixing member 111 is fitted may be formed at one side of the connecting member 121, but it is noted that the present invention is not limited thereto. For example, a groove into which the protruding fixing member 111 is fitted may be formed at one side of the connecting member 121.

Further, the connecting member 121 may have a thickness of 0.5 mm to 0.7 mm, but it is noted that the thickness of the connecting member 121 is not limited to the aforementioned thickness.

Meanwhile, the connecting member 121 may be made of engineering plastic. In this case, since the connecting member 121 is made of engineering plastic, it is possible to prevent a crack from being formed in the connecting member 121 as the connecting member 121 is bent when the connecting member 121 is fitted with the fixing member 111.

In addition, the connecting member 121 may be made of a flexible material. In this case, since the connecting member 121 is made of a flexible material, the connecting member 121 may be coupled to the fixing member 111 after the connecting member 121 is fitted with the fixing member 111 in a state in which the connecting member 121 is bent.

However, in this case, it is noted that the material of the connecting member 121 is not limited to the aforementioned material.

Meanwhile, referring to FIG. 2, an anti-withdrawal protrusion 111a, which prevents the fitted and coupled connecting member 121 from being withdrawn, may be formed at one side of the fixing member 111 according to the exemplary embodiment of the present invention.

In this case, a shape and a position of the anti-withdrawal protrusion 111a are not limited to the shape and the position illustrated in FIG. 2, and it is noted that the anti-withdrawal protrusion 111a may have other shapes and may be formed at other positions as long as the shape and the position of the anti-withdrawal protrusion 111a may prevent the fitted and coupled connecting member 121 from being withdrawn.

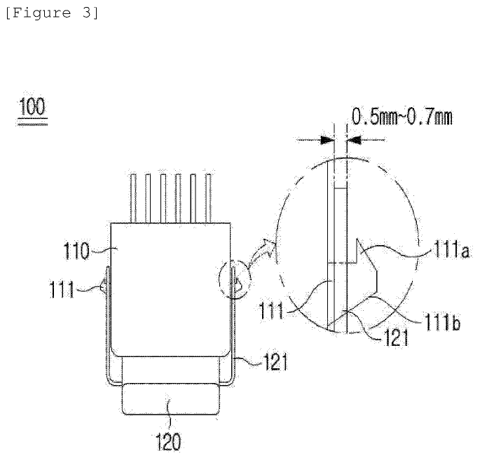

In addition, referring to FIG. 3, an inclined surface 111b, which allows the connecting member 121 to be easily fitted upward, may be formed at one side of the fixing member 111 (e.g., a lower side of the fixing member 111 as illustrated in FIG. 2) according to the exemplary embodiment of the present invention.

Therefore, the connecting member 121 may be easily fitted in the direction from the lower side to the upper side, and the anti-withdrawal protrusion 111a may prevent the connecting member 121 from being withdrawn after the connecting member 121 is fitted.

That is, according to the connector 100 having the locking structure according to the exemplary embodiment of the present invention, the female connector 120 is fitted with and coupled to the lower end of the male connector 110, and the fixing members 111 and the connecting members 121, which are formed at the left and right sides of the male connector 110 and the left and right sides of the female connector 120, respectively, are additionally coupled, and as a result, it is possible to effectively prevent the male connector 110 and the female connector 120 in the coupled state from being warped to the left and right.

While the specific exemplary embodiment of the present invention has been illustrated and described above, it is obvious to those skilled in the art that the technical spirit of the present invention is not limited to the attached drawings and the aforementioned descriptions, and the exemplary embodiment may be variously modified without departing from the technical spirit of the present invention, and it should be construed that the modified forms are included in the claims of the present invention without departing from the technical spirit of the present invention.

1. A connector having:
a male connector;
a female connector configured to be coupled to the male connector; and
a locking structure configured to doubly couple the male connector to the female connector, comprising:
a first fixing member that protrudes from a first side of the male connector, wherein the first fixing member has a predetermined size; and
a first connecting member on a first side of the female connector, wherein the first connecting member is adapted to be fitted with and coupled to the first fixing member when the male connector is coupled to the female connector.

2. The connector of claim 1, further comprising:
the a second fixing member that protrudes from a second side of the male connector opposite the first side, wherein the second fixing member has a predetermined size; and
a second connecting member on a second side of the female connector that is opposite the first side, wherein the second connecting member is adapted to be fitted with and locked to the second fixing member when the male connector is coupled to the female connector.

3. The connector of claim 1, wherein an anti-withdrawal protrusion, which prevents the fitted and coupled connecting member from being withdrawn, is formed at one side of the first fixing member.

4. The connector of claim 3, wherein an inclined surface, which allows the first connecting member to be fitted in a sliding manner, is formed at an opposing side of the first fixing member.

5. The connector of claim 1, wherein the first connecting member is made of engineering plastic.

6. The connector of claim 5, wherein the first connecting member is fitted with and coupled to the first fixing member after the first connecting member is fitted with the first fixing member in a state in which the first connecting member is bent.

7. The connector of claim 1, wherein the first connecting member has a thickness of 0.5 mm to 0.7 mm.

8. The connector of claim 1, wherein the first side of the male connector is either a left side or a right side of the male connector, and wherein the first side of the female connector is either a left side or a right side of the female connector.
